(19) United States
(12) Patent Application Publication
(10) Pub. No.: US 2005/0200106 A1
(43) Pub. Date: Sep. 15, 2005

(54) Vehicle passenger protecting device and method

(75) Inventors: Yoshinori Hirose, Toyota-city (JP); Makoto Aso, Nishikamo-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/019,445

(22) Filed: Dec. 23, 2004

(30) Foreign Application Priority Data
Mar. 12, 2004 (JP) 2004-70655

(51) Int. Cl. B60R 21/32

(52) U.S. Cl. 280/735

(57) ABSTRACT

In a passenger protecting device for a vehicle, an airbag is held in a steering wheel coaxially supported by a steering column which can be shifted in a central axis direction thereof by a telescopic unit. A steering sensor, a seat sensor and multiple driver sensors are provided to respectively detect positions of the steering wheel, a driver seat and a driver. An airbag control unit calculates a distance between the steering wheel and the driver based on the positions, and thus the airbag is deployed corresponding to the distance. Accordingly, a secondary impact to the driver due to the airbag can be effectively restricted.

### CROSS REFERENCE TO RELATED APPLICATION

This application is based on Japanese Patent Application No. 2004-70655 filed on Mar. 12, 2004, the disclosure of which is incorporated herein by reference.

### FIELD OF THE INVENTION

The present invention relates to a vehicle passenger protecting device and method for mitigating a damage to a driver in a collision of a vehicle.

### BACKGROUND OF THE INVENTION

In general, a vehicle is provided with a driver protecting unit such as an airbag and a seat belt. When a collision between the vehicle and an obstacle is detected or predicted, the airbag is deployed and the seat belt is retracted to alleviate an injury to the driver. On the other hand, a secondary impact to the driver due to the airbag spread and the seat belt retraction is to be restricted.

With respect to JP-5-213142A, for example, a position of a driver seat is detected so that the airbag is deployed corresponding to the position to reduce the secondary impact. However, in this case, the airbag is operated regardless of an axial displacement of a steering wheel in which the airbag for the driver is held generally. The steering wheel is coaxially supported by an axially displaceable steering column which is operated by a telescopic unit, so that the steering wheel can be axially shifted to deviate from the normal position thereof. Therefore, if the airbag is deployed only corresponding to the position of the driver seat in spite of that of the steering wheel, the secondary impact to the driver cannot be sufficiently restricted.

### SUMMARY OF THE INVENTION

In view of the above-described problem, it is an object of the present invention to provide a vehicle passenger protecting device and method, in which a driver protecting unit is adjusted corresponding to a steering wheel position to effectively reduce an impact to a driver.

According to the present invention, a vehicle passenger protecting device includes a collision detecting unit for detecting a collision or an imminent collision with the vehicle and generating a collision signal, a driver protecting unit for protecting the driver when the collision signal is generated, a steering sensor for detecting an axial position of the axially displaceable steering wheel, and a protecting control unit for adjusting the driver protecting unit based on the axial position of the steering wheel.

Accordingly, the driver protecting unit can be suitably operated to protect the driver substantially even when the steering wheel has deviated from a normal position thereof.

Preferably, the passenger protecting device is provided with a driver sensor and a seat sensor for detecting the positions of the driver and a driver seat, respectively. According to the detected positions, the protecting control unit calculates a distance between the steering wheel and the driver, so that an airbag as the driver protecting unit is deployed corresponding to the distance. Therefore, a secondary impact to the driver due to the deploying of the airbag can be sufficiently restricted.

### BRIEF DESCRIPTION OF THE DRAWINGS

Other objects, features and advantages of the present invention will become more apparent from the following detailed description made with reference to the accompanying drawings, in which:

FIG. 1 is a schematic diagram showing a passenger protecting device arranged in a vehicle according to a preferred embodiment of the present invention;

FIG. 2 is a flow diagram showing a normal procedure of the passenger protecting device according to the preferred embodiment; and

FIG. 3 is a flow diagram showing an interrupt procedure of the passenger protecting device according to the preferred embodiment.

### DETAILED DESCRIPTION OF THE PREFERRED EMBODIMENT

### Preferred Embodiment

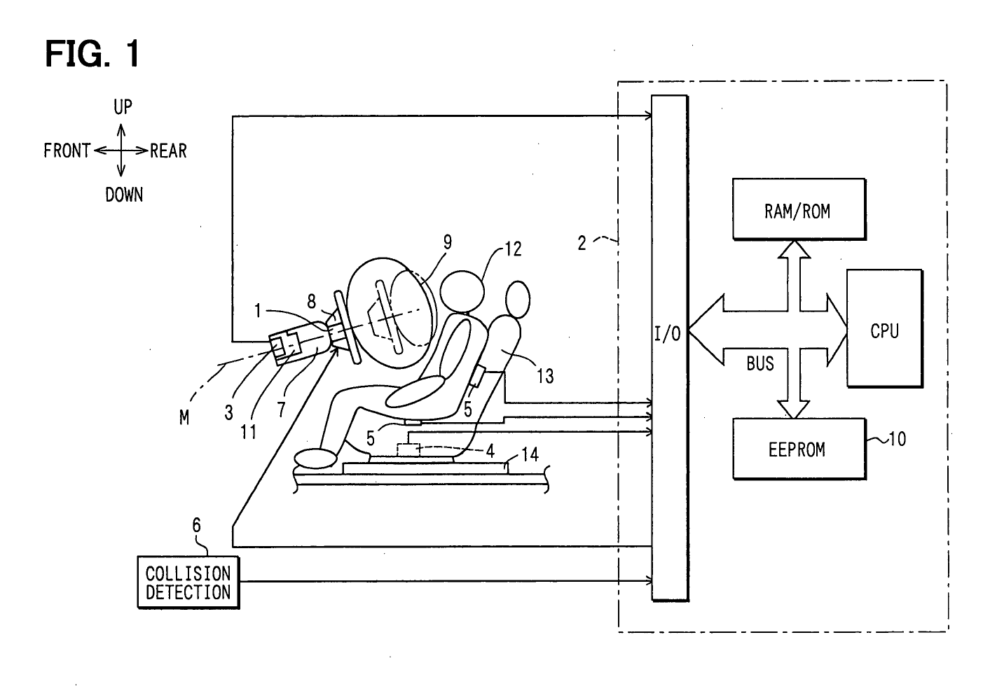

A preferred embodiment of the present invention will be described with reference to FIGS. 1-3.

A passenger protecting device is provided with a collision detecting unit 6 (e.g., collision sensor), a driver protecting unit 1 (e.g., airbag unit), a protecting control unit 2 (e.g., airbag control unit), a steering sensor 3, a seat sensor 4 and multiple driver sensors 5, as shown in FIG. 1. This passenger protecting device is arranged in a vehicle. The front-rear direction indicated in FIG. 1 corresponds to a longitudinal direction of the vehicle.

The collision sensor 6 (e.g., acceleration sensor) is provided to detect a collision with the vehicle. When a collision of the collision sensor 6 is larger than a predetermined value, the collision sensor 6 generates a collision signal which indicates that a driver 12 is to be protected by deploying an airbag 9.

The airbag unit 1 includes an airbag 9 accommodated in a center portion of a steering wheel 8, and an airbag activating apparatus (not shown) constructed of multiple inflators, for example. When the collision signal is generated, the inflators are activated to deploy the airbag 9 at the driver side of the steering wheel 8. The steering wheel 8 is coaxially supported by a steering column 7. The steering column 7 can be axially shifted by a built-in telescopic unit 11 which is mechanical or electrical operated. The central axis (indicated as M in FIG. 1) of the steering column 7 (steering wheel 8) is inclined to the vehicle front-rear direction. The telescopic unit 11 is mounted on a bracket (not shown) fixed to a vehicle chassis. Therefore, the steering wheel 8 can be axially shifted from the normal position thereof. That is, the steering wheel 8 may have a displacement in the vehicle front-rear direction.

The steering sensor 3 is constructed of multiple limit switches for determining an axial position (or equivalent amount) of the steering wheel 8. In this embodiment, an axial shifting range of the steering wheel 8 is divided into front, middle and rear parts. The steering sensor 3 detects which part the steering wheel 8 is positioned in and generates a position signal of the steering wheel 8.

The seat sensor 4 is constructed of multiple limit switches, which are arranged near a rail 14 at different positions in the vehicle front-rear direction to locate a driver seat 13 that can slide along the rail 14. A rod (not shown) is provided at the bottom of the driver seat 13 for contacting the multiple limit switches in order when the driver seat 13 is displaced, so that a vehicle front-rear direction position of the driver seat 13 can be determined. In this embodiment, a sliding range of the driver seat 13 is divided into front, middle and rear parts. The driver seat sensor 4 detects which part the driver seat 13 is disposed in and generates a position signal of the driver seat 13.

In the case where an electric power seat is used as the driver seat 13, an operation order for displacing the driver seat 13 is input to both a motor of the electric power seat and the airbag control unit 2, in which the position of the driver seat 13 will be determined.

The multiple driver sensors 5 are pressure sensors buried in the seated portion and the back portion of the driver seat 13 for detecting a pressure distribution thereat. According to detection signals of the driver sensors 5, the body shape and the posture of the driver 12 are determined. For example, when the detection signal from the back portion of the driver seat 13 is larger than a predetermined value, it is determined that the driver 12 does not incline forward to the side of the steering wheel 8 but leans against the back portion. According to the detection signal from the seated portion of the driver seat 13, a weight distribution (i.e., body shape) of the driver 12 can be determined. In this embodiment, a sitting range of the driver 12 is divided into front and rear positions with respect to the driver seat 13. According to the detected body shape and posture of the driver 12, it is determined that which position the driver 12 (e.g., driver head) lies in. Thus, a position signal of the driver 12 is generated.

The airbag control unit 2 includes a microcomputer constructed with a ROM, a RAM, a CPU (central processing unit), a nonvolatile memory 10 (EEPROM) and the like, which are communicated with the steering sensor 3, the seat sensor 4 and the driver sensors 5 through a bus and the like. According to the position signal input by the above-described sensors, the airbag control unit 2 determines an activation mode of the airbag 9 and generates a corresponding order to the airbag activating apparatus to deploy the airbag 9.

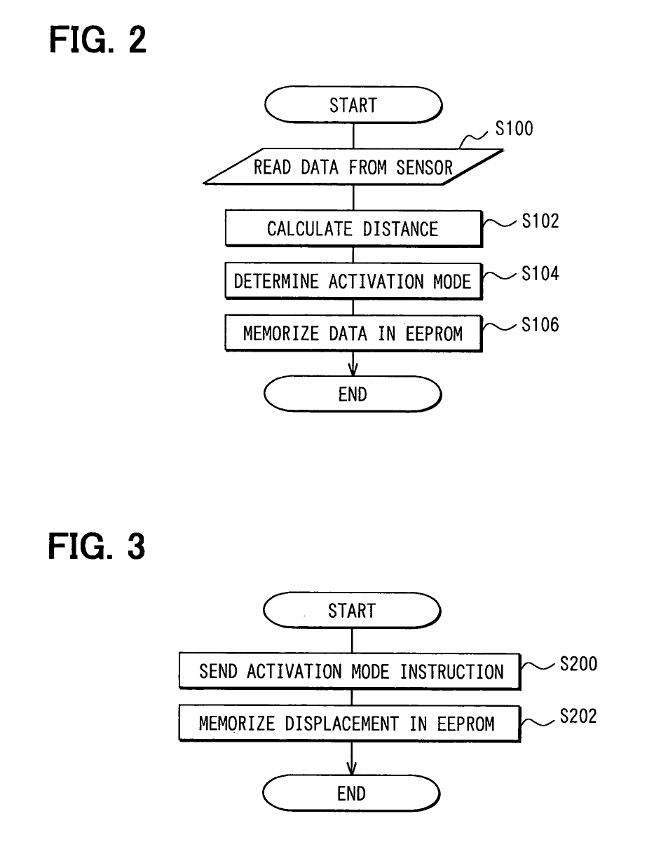

Next, a control operation of the vehicle passenger protecting device will be described. When an electrical power is supplied to the airbag control unit 2, the microcomputer therein executes a normal procedure as shown in FIG. 2 based on a control program saved in the microcomputer.

At first, at step S100, the position signals of the steering wheel 8, the driver seat 13 and the driver are input to the airbag control unit 2.

At step S102, according to the input position signals, the airbag control unit 2 calculates the distance between the steering wheel 8 and the driver head, and thus determines whether the distance is shorter than a predetermined value or not.

At step S104, the airbag control unit 2 determines the activation mode of the airbag 9 according to the distance. In this embodiment, the airbag 9 is provided with two selective activation modes including an early activation mode in which the airbag 9 is deployed as early as possible by a small deploying force by activating a single inflator, and a normal activation mode in which the airbag 9 is speedily deployed by a large deploying force by activating multiple inflators. When the distance between the steering wheel 8 and the driver head is smaller than the predetermined value, it is determined that a secondary impact due to an airbag spread may occur so that the early activation mode is chosen to restrict the secondary impact to the driver 12 by deploying the airbag 9 with the small force. When the distance is larger than or equal to the predetermined value, it is determined that a secondary impact due to an airbag spread will not occur so that the normal activation mode is chosen to restrict an impact due to the collision of the vehicle by rapidly deploying the airbag 9 with the large force.

At step S106, data including the input position signals, the calculated distance and the chosen activation mode are memorized in the nonvolatile memory 10. After a predetermined time “t” passes from step S106, the CPU starts to execute the control program from step S100 again, so that the data memorized in the nonvolatile memory 10 are updated. That is, the previous data memorized by means of the last control operation are replaced by the current data. Therefore, as described later, when a collision signal is generated, the airbag 9 can be deployed at the current chosen activation mode which corresponds to the current distance between the driver head and the steering wheel 8. Accordingly, the driver 12 can be effectively protected.

FIG. 3 shows an interrupt procedure that will be preferentially performed to interrupt other procedures, when a collision signal is generated by the collision sensor 6.

As described above, when the collision sensor 6 detects a collision of the vehicle which is larger than the predetermined value, the collision sensor 6 will generate a collision signal. The collision signal is input to the airbag control unit 2, so that the interrupt procedure is started and the other procedures such as the normal procedure are interrupted.

At step S200, the airbag control unit 2 sends an operation instruction to the airbag activating apparatus, so that the airbag 9 is deployed at the current chosen activation mode memorized in the nonvolatile memory 10.

At step S202, an axial displacement of the steering wheel 8 during the deploying of the airbag 9 is memorized in the nonvolatile memory 10, thereby renewing the current data of the steering wheel 8. Thus, the interrupt procedure is ended.

In the vehicle passenger protecting device, the airbag 9 is deployed corresponding to the current distance between the driver head and the steering wheel 8 despite the position of the sole driver seat 13, so that the driver 12 can be sufficiently protected against the impact in the collision of the vehicle.

### Other Embodiment

Although the present invention has been fully described in connection with the preferred embodiments thereof with reference to the accompanying drawings, it is to be noted that various changes and modifications will become apparent to those skilled in the art.

For example, the telescopic unit 11 can be electrically operated by the airbag control unit 2. Therefore, when a collision signal is generated, the electric telescopic unit 11 can be adjusted to axially shift the steering wheel 8 so as to enlarge the distance from the driver 12, and thus the airbag 9 is deployed so that the secondary impact to the driver head is reduced. In this case, the axial displacement of the steering wheel 8 will be memorized in the nonvolatile memory 10, so that the current data of the steering wheel 8 is renewed.

Moreover, the position of the steering wheel 8 can be specifically determined by detecting axial coordinates of the steering wheel 8. Similarly, the position of the driver seat 13 can be also determined by detecting its coordinates in the vehicle front-rear direction.

Moreover, a radar can be also used to predict an imminent collision with the vehicle.

Furthermore, when the collision detected by the collision sensor 6 is larger than the predetermined value, the airbag control unit 2 can also determine that the driver 12 is to be protected by deploying the airbag 9 and generates the collision signal. Similarly, the airbag control unit 2 can also determine the body shape and the posture of the driver 12 according to the detection signal of the driver sensors 5.

A photo sensor or the like can be also used to detect the posture of the driver 12 by photographing the upper half of the driver 12.

Various kinds of displacement sensors can be also used as the steering sensor 3 and the seat sensor 4.

Such changes and modifications are to be understood as being in the scope of the present invention as defined by the appended claims.

1. A passenger protecting device for a vehicle, the passenger protecting device comprising:
a collision detecting unit for detecting one of a collision and an imminent collision of the vehicle and generating a collision signal;
a driver protecting unit for protecting a driver of the vehicle when the collision signal is generated;
a steering sensor for detecting an axial position of an axially displaceable steering wheel of the vehicle; and
a control unit for controlling the driver protecting unit based on the axial position of the steering wheel when the driver protecting unit is activated.

2. The passenger protecting device according to claim 1, wherein:
the driver protecting unit is an airbag held in the steering wheel; and
when the collision signal is generated, the airbag is activated in one of multiple activation modes which is determined by the control unit according to the axial position of the steering wheel.

3. The passenger protecting device according to claim 2, wherein at least one of an airbag activating timing and an airbag activating speed in each of the multiple activation modes is different from each other.

4. The passenger protecting device according to claim 3, wherein the activation modes include an early activation mode in which the airbag is activated as early as possible by a small activating force, and a normal activation mode in which the airbag is speedily activated by a large deploying force.

5. The passenger protecting device according to claim 1, wherein:
the driver protecting unit is an airbag held in the steering wheel; and
the control unit controls activation of the airbag by adjusting the axial position of the steering wheel, when the collision signal is generated.

6. The passenger protecting device according to claim 1, further comprising:
a seat sensor for detecting a position of a driver seat of the vehicle,
wherein the control unit controls the driver protecting unit based on both the position of the driver seat and the axial position of the steering wheel.

7. The passenger protecting device according to claim 1, further comprising:
a driver sensor for detecting a position of the driver,
wherein the control unit controls the driver protecting unit based on both the position of the driver and the axial position of the steering wheel.

8. The passenger protecting device according to claim 1, further comprising:
a seat sensor for detecting a position of a driver seat of the vehicle; and
a driver sensor for detecting a position of the driver, wherein the control unit controls the driver protecting unit based on all of the axial position of the steering wheel, and the positions of the driver and the driver seat.

9. The passenger protecting device according to claim 1, wherein the control unit has a nonvolatile memory for memorizing the current axial position of the steering wheel.

10. The passenger protecting device, according to claim 1, wherein the collision detecting unit is one of an acceleration sensor and a radar.

11. A passenger protecting method for a vehicle, comprising:
calculating a distance between a driver and a steering wheel of the vehicle;
determining an activation mode of an airbag in the vehicle based on the distance;
memorizing data including the distance and the activation mode in a nonvolatile memory;
detecting one of a collision and an imminent collision of the vehicle to generate a collision signal; and
activating the airbag in the activation mode memorized in the nonvolatile memory, wherein:
the calculating of the distance, the determining of the activation mode and the memorizing of the data are periodically performed; and
the activating of the airbag is performed in response to the collision signal.

12. The passenger protecting method according to claim 11, further comprising:
adjusting the distance in response to the collision signal as well as the activating of the airbag.
